(19) United States
(12) Patent Application Publication
(10) Pub. No.: US 2011/0151718 A1
(43) Pub. Date: Jun. 23, 2011

(54) AC adapter capable of connecting external AC power

(76) Inventor: Sheng-Fu Lu, Taoyuan (TW)

(21) Appl. No.: 12/003,956

(22) Filed: Jan. 3, 2008

(51) Int. Cl. H01R 13/66

(52) U.S. Cl. 439/620.21

(57) ABSTRACT

An AC adapter connected to an external AC power includes a main body, an input plug, a transforming and rectifying circuit, and a connecting cable. The overload protection circuit is electrically connected to the input plug for inputting AC power and preventing a circuit from having a load with a large current. The external AC power socket is connected to the overload protection circuit for outputting a stable AC power, and connected to an external power connector for supplying AC power. With the feature of the AC adapter being connected to an output of an external expanded AC power, several adapters can be stacked with each other and connected to the external AC power, without occupying the position of an insert slot, while providing an application of connecting several adapters to an external AC power.

### BACKGROUND OF THE INVENTION

1. Field of the Invention

The present invention relates to a small portable adapter, and more particularly to an AC adapter capable of connecting to an external AC power.

2. Description of the Related Art

Referring to FIG. 1 for a schematic view of a prior art AC adapter, the AC adapter 10 installs a transforming and rectifying circuit for inputting AC power to be converted into DC power. However, this kind of AC adapters inserted into a power socket for inputting AC power simply provides the function of rectifying and converting power, but it also occupies the position of an insert hole of a socket. As present electronic products become increasingly popular, the demand for AC adapter increases drastically, and one battery charger cannot satisfy the required applications of the expanded power supply.

Therefore, it is an important subject for manufacturers to overcome the foregoing shortcomings of the prior art and develop an AC adapter having a rectifying and converting function, and being capable of connecting an external AC power for an output of the required power.

### SUMMARY OF THE INVENTION

The primary objective of the present invention is to provide a small portable AC adapter capable of connecting an external AC power, and the design of an overload protection circuit and an external AC power socket is added to the original components, not only providing the rectifying and converting functions, but also forming a socket capable of outputting AC power.

To achieve the foregoing objective, the present invention provides an AC adapter capable of connecting an external AC power, and the AC adapter comprises a main body, an input plug, a transforming and rectifying circuit, an overload protection circuit and an external AC power socket. The main body is built for containing any of the input plug, charge rectification circuit, charge slot, overload protection circuit and external AC power socket to provide an insulation protection. The input plug is inserted into the power socket for inputting AC power, and the transforming and rectifying circuit is electrically connected to the input plug for inputting an AC power to be converted and rectified to an output of required DC power output. The overload protection circuit is connected to the input plug for inputting the AC power and preventing a load of a large current on the circuit. The external AC power socket is connected to the overload protection circuit for outputting a stable AC power, and connected to an external power connector for supplying AC power.

To make it easier for our examiner to understand the objective, shape, structure, apparatus, characteristics and performance of the present invention, the following detailed description with reference to the accompanying drawing of preferred embodiments is given for example, but such preferred embodiments are not intended to limit the scope of the present invention.

### BRIEF DESCRIPTION OF THE DRAWINGS

FIG. 1 is a schematic view of a prior art AC adapter;

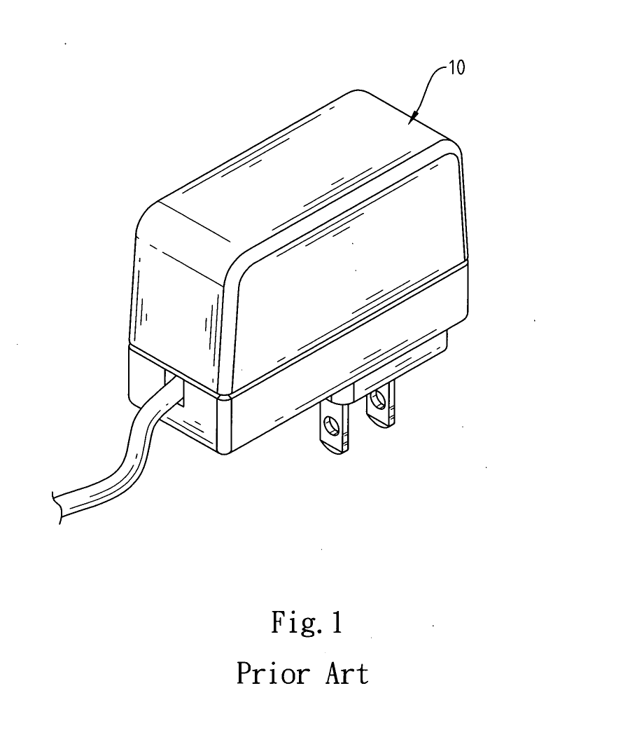

FIG. 2 is a schematic view of an AC adapter connected to an external AC power in accordance with the present invention;

FIG. 3 is a schematic view of the connection of related components of an AC adapter connected to an external AC power in accordance with the present invention;

FIG. 4 is a schematic view of an AC adapter connected to an external AC power in accordance with a preferred embodiment of the present invention; and

FIG. 5 is a schematic view of a plurality of AC adapters stacked with each together for connecting an external AC power supply in accordance with a preferred embodiment of the present invention.

### DETAILED DESCRIPTION OF THE PREFERRED EMBODIMENTS

The description and its accompanied drawings are used for describing a preferred embodiment of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

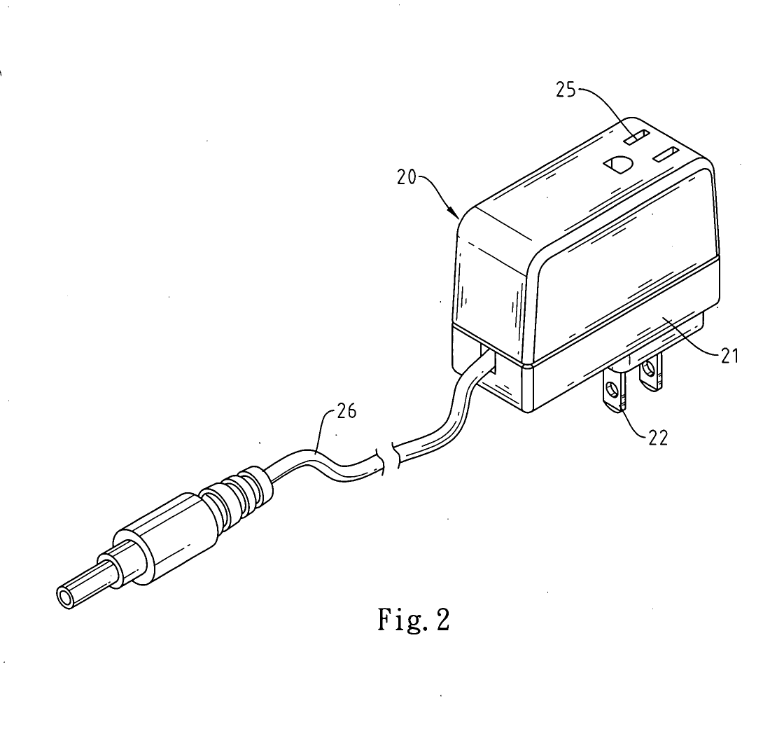

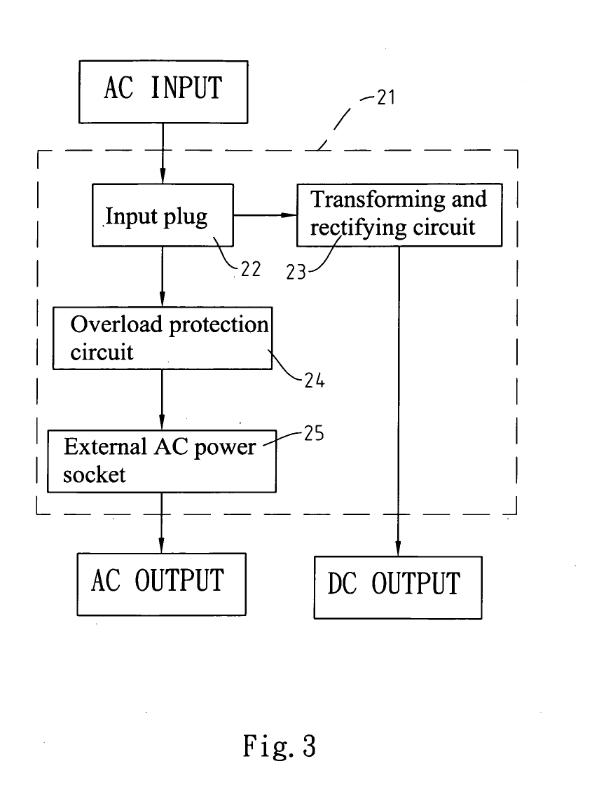

Referring to FIGS. 2 and 3 for schematic views of an AC adapter connected to an external AC power, the AC adapter 20 comprises a main body 21, an input plug 22, a transforming and rectifying circuit 23, an overload protection circuit 24, an external AC power socket 25, and a connecting cable 26.

The main body 21 is built for containing any of the input plug 22, transforming and rectifying circuit 23, overload protection circuit 24 and external AC power socket 25 to provide an insulating protection for the aforementioned components, and the input plug 22 is inserted into the power socket for inputting AC power, and the transforming and rectifying circuit 23 is electrically connected to the input plug 22 for inputting an AC power to be converted and rectified into the required DC power which is outputted from a conducting wire at an end, and the overload protection circuit 24 is electrically connected to the input plug 22 for inputting an AC power supply and preventing a load with a large current on the circuit, and the external AC power socket 25 is electrically connected to the overload protection circuit 24 for outputting a stable AC power, so that the external AC power socket 25 can be connected to a load device that requires an AC power, and prevent the external load device from having a load of a large current. The invention provides a safety protection for the power supply, and prevents the power supply from being damaged by the overload of power supply.

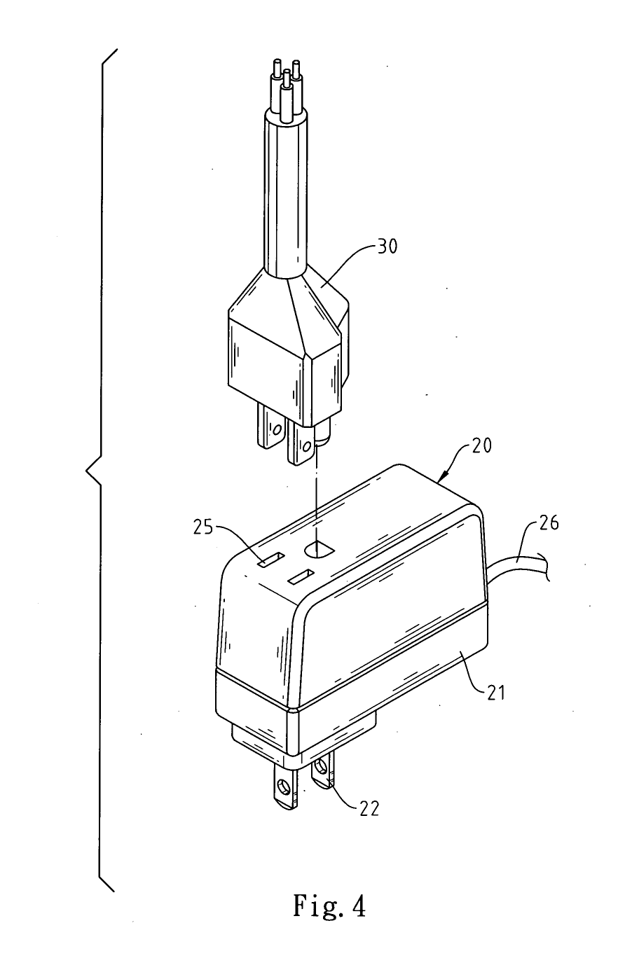

In the preferred embodiment as shown in FIG. 4, the AC adapter of the invention has a feature of connecting an external expanded AC power, such that a load device can be inserted into an external AC power socket 25 through a power connector 30 for supplying the required stable AC power, and the AC adapter of the invention not only has the rectifying and converting function, but also connects a socket of an external AC power output. The present invention does not occupy an insert slot of the socket when the AC adapter charger is inserted into the power socket. The connecting cable 26 connected to the main body 21 of the AC adapter can be used for charging the battery of an electronic product (such as a mobile phone), and the AC adapter of the present is small in size and easy to carry.

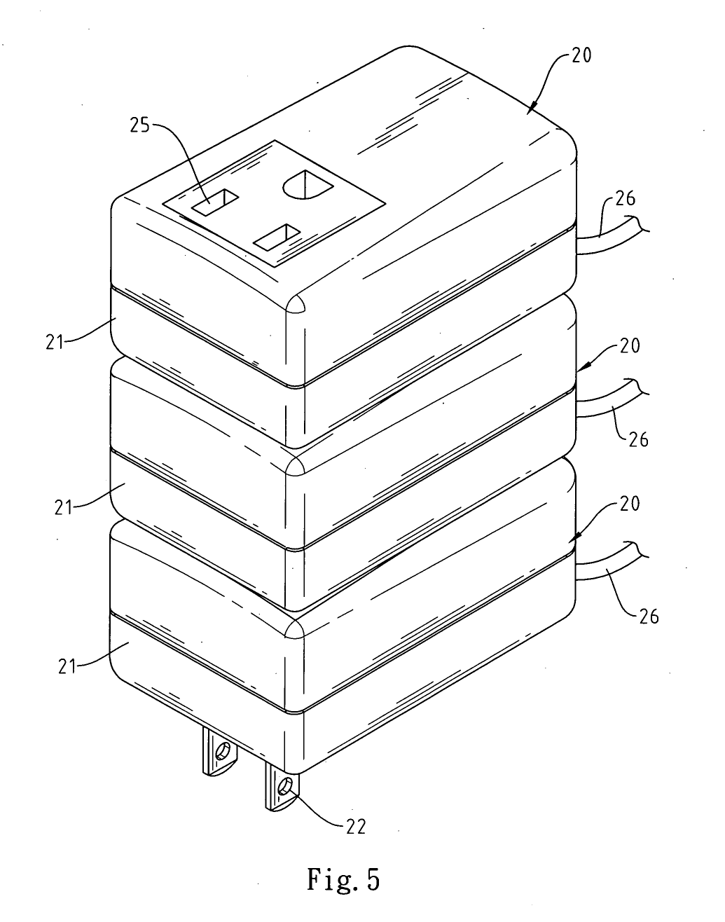

In the preferred embodiment as shown in FIG. 5, the AC adapter of the invention has a feature of connecting an external expanded AC power, and a plurality of AC adapters are stacked with each other to connect an external AC power without occupying an insert slot of the socket, while providing an application of connecting several AC adapters to an external AC power.

In summation of the description above, the present invention provides an AC adapter connected to an external AC power, and the design of an overload protection circuit and an external AC power socket is added to the original components, not only providing the rectifying and converting functions, but also forming a socket capable of outputting AC power. Obviously, the invention complies with the requirements of patent application, and thus is duly filed for patent application.

The description and its accompanied drawings are used for describing a preferred embodiment of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What the invention claimed is:

1. An AC adapter capable of connecting an external AC power, comprising a main body, an input plug, a transforming and rectifying circuit, and a connecting cable, and said input plug being inserted into said power socket for inputting an AC power, and said transforming and rectifying circuit being electrically coupled to said input plug for converting and rectifying the AC power into an output of a required DC power, wherein said main body of said AC adapter comprises an overload protection circuit and an external AC power socket, and said overload protection circuit is electrically coupled to said input plug, for inputting an AC power supply and preventing said circuit from having a load of a large current.
